(19) United States
(12) Patent Application Publication
(10) Pub. No.: US 2025/0297972 A1
(43) Pub. Date: Sep. 25, 2025

(54) X-RAY SYSTEM

(71) Applicant: Fraunhofer-Gesellschaft zur Förderung der angewandten Forschung e.V., München (DE)

(72) Inventor: Michael SALAMON, Erlangen (DE)

(73) Assignee: Fraunhofer-Gesellschaft zur Förderung der angewandten Forschung e.V., München (DE)

(21) Appl. No.: 19/079,400

(22) Filed: Mar. 13, 2025

Related U.S. Application Data
(63) Continuation of application No. PCT/EP2023/075153, filed on Sep. 13, 2023.

(30) Foreign Application Priority Data
Sep. 14, 2022 (WO) PCT/EP2022/075499

(51) Int. Cl. G01N 23/083; G01N 23/18

(52) U.S. Cl. CPC G01N 23/083; G01N 23/18; G01N 2223/1016; G01N 2223/3307; G01N 2223/646

(57) ABSTRACT

X-ray system for non-destructive material inspection of an object to be irradiated, in particular of a battery module of a vehicle, or a battery module incorporated in a vehicle, comprising at least one radiation source; at least one radiation detector; wherein the object to be irradiated is arranged between the at least one radiation source and the at least one radiation detector, wherein the at least one radiation source is arranged spaced apart from the object to be irradiated with at least two times, or at least three times, or at least five times the width of the scanning area (such that a fan-shaped radiation geometry is formed at least in transverse direction), wherein the opening angle of the radiation geometry is less than 10°.

### CROSS-REFERENCE TO RELATED APPLICATIONS

This application is a continuation of copending International Application No. PCT/EP2023/075153, filed Sep. 13, 2023, which is incorporated herein by reference in its entirety, and additionally claims priority from International Application No. PCT/EP2022/075499, filed Sep. 14, 2022, which is also incorporated herein by reference in its entirety.

Embodiments of the present invention relate to an X-ray system for non-destructive material testing of an object to be irradiated, in particular a battery module (such as a high-voltage battery) of a vehicle or a battery module incorporated in a vehicle. Further embodiments relate to a method for determining an X-ray picture as well as to a computer program. Generally, embodiments of the invention are in the field of fast battery inspection at the entire vehicle by means of X-ray technology.

### BACKGROUND OF THE INVENTION

Insight into the inside of a battery module of an e-vehicle is so far not possible in a non-destructive manner. Here, the mechanical integrity of the battery modules, for example after accidents, plays an important part for judging the options of vehicle repair. The method can also be used for assessing the state of the vehicle with unclear vehicle history in the second-hand car market. Therefore, there is a need for an improved approach.

### SUMMARY

According to an embodiment, an X-ray system for non-destructive material inspection of a battery module of a vehicle to be irradiated or a battery module incorporated in a vehicle may have: at least one radiation source; at least one radiation detector; wherein the object to be irradiated can be arranged between the at least one radiation source and the at least one radiation detector, wherein the at least one radiation source is arranged spaced apart from the object to be irradiated with at least five times the width of the scanning area, such that a fan-shaped radiation geometry is formed at least in transverse direction, wherein the scanning area of the width of the object, wherein the scanning area corresponds to the width of the object in transverse direction, or wherein the scanning area corresponds to a part of the width of the object in transverse direction; wherein the opening angle of the radiation geometry is less than 5° in transverse direction and wherein the opening angle of the radiation geometry is less than 10° in advance direction.

According to another embodiment, a method for determining an X-ray picture by using an inventive X-ray system may have the steps of: irradiating an object to be irradiated at a distance of the radiation source from the object to be irradiated of at least two times, at least three times, or at least five times the width of the scanning area to obtain a first picture, such that a fan-shaped radiation geometry is formed, at least in transverse direction; wherein the scanning area corresponds to the width of the object in transverse direction, or wherein the scanning area corresponds to part of the width of the object in transverse direction.

Another embodiment may have a non-transitory digital storage medium having a computer program stored thereon to perform the method for determining an X-ray picture by using an X-ray system, when said computer program is run by a computer.

Embodiments of the present invention provide an X-ray system for non-destructive material testing of an object to be irradiated, such as a battery module of a vehicle or a battery module incorporated in a vehicle. The X-ray system includes at least one radiation source and at least one radiation detector. The object to be irradiated, such as the vehicle or the vehicle battery, is incorporated in the vehicle, arranged between the at least one radiation source and the at least one radiation detector, wherein the at least one radiation source is arranged spaced apart from the object to be irradiated with at least two times, or at least three times, or at least five times the width of the scanning area, such that a fan-shaped radiation geometry is formed at least in transverse direction. According to embodiments, the scanning area can correspond to the width of the object or only part of the width of the object, i.e., that only part of the object is imaged in transverse direction. The opening angle of the radiation geometry is <10°.

According to embodiments, the distance between radiation source and object to be irradiated can be at least 5 m or even at least 10 m. It has been found that good scanning of an object of 2 m width is possible at 11 m or at least 11 m. The 10° radiation geometry as well as the distance aims in particular at the object being able to be scanned across its width or at least a sufficiently wide scanning area in object width (transverse direction).

According to embodiments, for scanning the object in longitudinal direction in a good way, the object can be moved in advance direction or can be moved continuously. The advance direction can mean, for example, perpendicular to the transverse direction.

For less than, for example, 10 m or less than, for example, 5 m, such as 3 m, to be sufficient, the at least one radiation source can be formed by several individual radiation sources. For example, the at least one radiation source is formed by several individual radiation sources arranged transverse to the object. If, for example, two radiation sources are assumed, the distance can be reduced from 10 m to 5 m. If three individual radiation sources are assumed, the distance can be reduced from 10 m to 3 m, approximately. This means that, according to embodiments, several radiation sources are provided, which are here referred to as individual radiation sources. Thus, according to embodiments, the distance is at least 2 m or at least 3 m to the object to be irradiated. In embodiments with the high-voltage battery/battery module to be irradiated, the high-voltage battery/the battery module is the object to be irradiated. This can either be tested in its full width such that a respectively large scanning area results or only partially such that only a small scanning area (per radiation source) and hence a smaller radiator-object distance results.

According to embodiments, the distance from the radiation source is measured with respect to the vehicle battery (battery module) to be irradiated or the surface of the vehicle battery to be irradiated facing the radiation source. A vehicle battery to be irradiated is typically a rectangular object whose main extension direction is arranged in longitudinal direction of the vehicle or in width direction of the vehicle. A square length-width ratio or an approximately square length-width ratio is also possible. In depth, the vehicle battery frequency frequently has a height of a few centimeters, such as 10 cm, 15 cm, or 20 cm. With the explained arrangement of a radiation source radiating in depth direction or parallel to the depth direction, the object can be well scanned along the 10 cm height, wherein a good resolution is possible across the length and width, as already explained above.

In the above embodiments, it has been assumed that the battery extending in length and width direction essentially perpendicular to the radiation direction, is irradiated
either by a widely spaced radiation source, e.g., at least 10 m,
or by several, e.g., spaced apart by 3 m or 5 m, radiation sources arranged transversely to the advance direction.

In both irradiation variations, the opening angle of the radiation geometry is limited to 10°.

Embodiments of the present invention are based on the finding that by the combination of large distance and low ray cone width, a radiation geometry is formed that allows a sharp image of gaps (between individual cells) prevailing in length or width direction in the battery module. Here, advantageously, the X-ray energy can be chosen to be only so high that it is possible to reach through sheet-metal structures of the vehicle, but not necessarily through the entire battery cells. This also allows that the gaps between battery cells are easily found, as the same have less absorption compared to the battery cells. In that way, defects, e.g., contacts of battery cells indicating battery defects, can be detected easily and efficiently.

Therefore, the X-ray source is configured to provide energy of a maximum of 450 keV or even of a maximum of 360 keV. Thus, the energy is selected to be so low that no irradiation of an intact object (intact battery cell) takes place, but only irradiation of gaps between the battery cells.

In the embodiment with the several individual radiation sources, there are different variations. According to one embodiment, the radiation geometries of the individual radiation sources can form overlapping radiation fields and/or radiation fields overlapping in the focal plane. Here, a small overlap, such as a maximum of 10% of the radiation field width, is possible. According to further embodiments, the radiation geometries of the individual radiation fields can overlap in a large area (also in the focal plane). In this variation, according to embodiments, alternating operation of the individual radiation sources is selected.

According to embodiments, the X-ray detector extends across the entire width of the object. According to further embodiments, the X-ray detector is formed by a line detector or an area detector extending across the width of the object. According to embodiments, the X-ray system comprises several radiation detectors or radiation sources arranged along an advance direction. The usage of several X-ray detectors has the advantage that in that way, several X-ray pictures are obtained from slightly different perspectives, such that overlapping objects, such as parts of the vehicle body that exist in non-focal planes can be detected during irradiation of a vehicle with a high-voltage battery to be irradiated and can then be masked out at a later time. Therefore, according to embodiments, the X-ray system comprises an evaluation apparatus configured to evaluate several pictures across several positions and/or several pictures across several radiator-detector combinations. The evaluation apparatus is configured to detect overlapping objects in the individual pictures based on several pictures and/or to compensate the images of an overlapping object in the individual X-ray pictures, e.g., by subtraction. According to further embodiments, the X-ray system comprises an evaluation apparatus that is configured to detect an overlapping object based on a reference picture of the object to be irradiated and/or to compensate the images of the overlapping object in the individual pictures. According to a further embodiment, the evaluation apparatus can also select the picture with little or no overlap or can prefer the same over another picture. According to further embodiments, the evaluation apparatus comprises an Al algorithm that is configured to detect such overlapping objects. Further, the evaluation apparatus is configured to detect morphological features. For example, the evaluation apparatus can be configured to detect deviations of the object or parts of the object from a normal form. When a cylindrical cell or a prismatic cell is deformed, there are deviations from the cylindrical or prismatic normal form. Also, the evaluation can detect deviations of the gap width from a normal form. Here, emphasis is placed in particular to lower deviations of the normal gap width. Therefore, the evaluation apparatus can be configured to determine a distance between lines of an object, such as cells of a battery module.

With regard to the X-ray system, it should further be noted that the radiation geometry of <10° can be obtained by collimating individual rays. For example, each radiation source or individual radiation source can comprise a collimator.

In order to adapt the focus or to adapt the X-ray system to several sources, according to embodiments, the distance between the at least one X-ray source and the object to be irradiated (and hence also to the radiation detector) can be adapted. This is particularly advantageous when different objects, such as different vehicles (SUV or normal car), are to be radiated.

A further embodiment relates to a method having the main step: irradiating an object to be irradiated at a distance of the radiation source from the object to be irradiated of at least two times, at least three times, or at least five times the width of the scanning area to obtain a first picture.

Further, the method can comprise the step of repeating the step of irradiating for a further picture. Further, the method can also comprise the step of compensating an overlapping object based on detecting the overlapping object in the picture with the help of the further picture.

According to further embodiments, the method can be computer-implemented. This means that a further embodiment relates to a computer program.

### BRIEF DESCRIPTION OF THE DRAWINGS

Embodiments of the present invention will be detailed subsequently referring to the appended drawings, in which:

FIG. 1a1, 1a2, 1b1, 1b2 are schematic illustrations for illustrating the irradiation of an object, such as a vehicle with vehicle battery, when using conventional technologies for illustrating the problems addressed by the invention;

FIG. 2 is a schematic block diagram for illustrating an X-ray system according to a basic embodiment of the invention;

FIG. 3a1, 3a2, 3b1, 3b2 are schematic illustrations for irradiating an object, here a vehicle with battery, according to an extended embodiment;

FIG. 4a1, 4a2, 4b1, 4b2 are schematic illustrations of X-ray systems according to extended embodiments;

FIG. 5a-5c is a schematic illustration for illustrating a further aspect according to further embodiments;

FIG. 6a-6c are schematic block diagrams for illustrating processing X-ray signals for absorption of extended embodiments; and

FIG. 7a-7d are exemplary radiation pictures taken by an X-ray system according to embodiments.

### DETAILED DESCRIPTION OF THE INVENTION

Before embodiments of the present invention will be discussed below based on the accompanying drawings, it should be noted that equal elements and structures are provided with the same reference numbers such that the description of the same is inter-applicable or exchangeable.

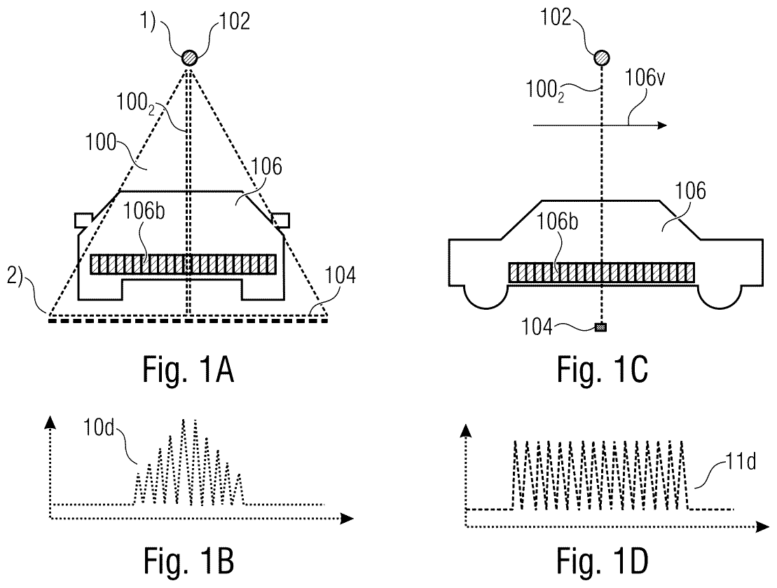

FIG. 1 shows an X-ray system with an X-ray geometry 100 that is essentially defined by the arrangement of radiation source 102 and detector 104. The geometry is illustrated in FIG. 1a1 in transverse direction and in FIG. 1b1 along the longitudinal direction. The object to be irradiated 106b is, for example, a high-voltage battery of a vehicle 106. The vehicle 106 is irradiated in FIG. 1a1 in transverse direction and in FIG. 1b2 in longitudinal direction. The detector 104 can be, for example, a line detector 104 that is arranged in transverse direction, i.e., in transverse direction to the vehicle 106. For irradiating in longitudinal direction of the vehicle 106, or, in particular, the battery module 106b, the object is moved in advance direction 106v according to a variation.

The object to be irradiated 106b is a high-voltage battery (lithium ion battery) comprising, for example cells (individual cells of different shapes, cylindrical or prismatic), that are separated by gaps. Here, the irradiation direction of the irradiation geometry 100 is selected such that the gaps between the cells are irradiated in radiation direction. This is clearly illustrated based on the parallelism of the central ray 100z of the radiation geometry. Due to the irradiation of the battery module 106b with the battery cells and the gaps, maxima are formed in the gaps and minima are formed in the cells. This irradiation pattern is shown based on the diagram 10d in transverse direction (cf. FIG. 1a2) and 11d in longitudinal direction (cf. FIG. 1b2). As can be seen, the diagram 10d has a good resolution around the central ray 100z, but a medium or strongly decreasing resolution in the outer areas of the radiation geometry 100. In longitudinal direction, scanning is performed mainly in the area of the central ray 100z through which the vehicle 100 with the battery module 100b is moved in advance direction 106v. The situation illustrated herein represents the starting situation for embodiments of the invention where the vehicle 106 with the battery module 106b is x-rayed. Parts of this explanation are already aspects of the invention, such as the optional usage of the advance 106v along the longitudinal direction of the vehicle 106. As shown based on FIG. 1a2, there are significant problems regarding the resolution of the object 106b in transverse direction. The illustrated simplified absorption profile illustrates the contrast decrease of the edge region within the modules resulting from the skewed illustration. Such already known picture geometries and approaches are hands-on suitable for the object of battery cell testing. Here, it should be noted that in the discussion of subsequent embodiments three different directions are used, namely:
Irradiation direction: this is the direction along the radiation propagation parallel to the central ray 100z of the radiation source/X-ray source 102.
Advance direction: in some embodiments it is assumed that the object 106 or 106b is moved through the radiation geometry 100 in an advance direction 106v during irradiation. This is the advance direction 106v. This advance direction 106v is orthogonal or essentially orthogonal to the irradiation direction, wherein this applies both to the embodiment illustrated herein of irradiating a vehicle 106 from a bird's eye view, but also for another irradiation, such as from the side.
Width direction: this direction defines, in the radiation geometry 100, the irradiation width that is essentially determined by the opening angle of the radiation geometry 100 and the width of the detector 104. Thus, the transverse direction extends along the width of the detector 104 and typically perpendicular to the advance direction. Further, the transverse direction is essentially orthogonal to the irradiation direction.
Longitudinal direction: for embodiments without advance, the advance direction can also be referred to as longitudinal direction when, for example, an area detector is used instead of a line detector.

In particular, for optimizing the resolution in transverse direction, the following structure of an X-ray system or an X-ray arrangement is suggested.

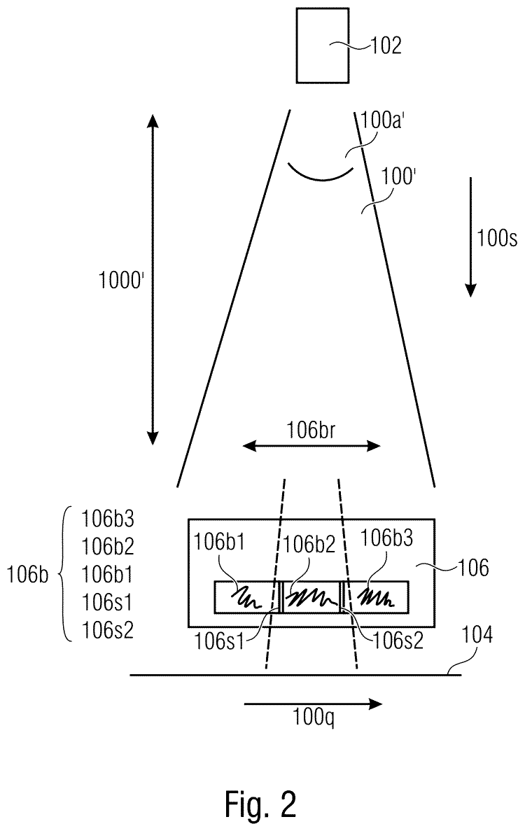

FIG. 2 shows a radiation source 102 with an opposing radiation detector 104. The same are spaced apart such that the radiation geometry 100′ is formed. The same serves to irradiate the object 106 with the battery cells 106b. Exemplarily, three battery cells 106b1, 106b2 and 106b3 are illustrated. Between the same, gaps 106s1 and 106s2 are formed. The same are essentially longitudinal to the irradiation direction 100s. The detector 104 is arranged transversely to the irradiation direction 106 (cf. transverse direction 100q). The geometry 100′ is characterized by two specific features, namely the opening angle 100a′ of the geometry 100′ that is limited to 10° or less (≤10°), as well as the distance 100d′. Compared to conventional radiation detector structures, the spanned opening angle is aligned essentially according to the minimum distance of the overall position and not according to the specific requirements from the analysis, such as battery cell analysis. This distance 100d′ is at least two times, or at least three times, or at least five times the width of the scanning area of the object 106. In this embodiment, the scanning area corresponds to the width 106br of the object 106. The greater the distance 100d′ compared to the scanning area, the more parallel are the rays to the irradiation direction 100s. If, for example, an object width of 2.2 m is assumed, for factor 5, a distance of 100d′ of 11 m results. This distance is determined between the object to be irradiated 106b and the radiation source 102 or the focal spot of the radiation source 102. Here, the surface of the object 106b facing the radiation source 102 is relevant. This is important to note, as for an application, the batteries 106b of an electric vehicle 106 are to be irradiated, which are typically arranged in the underbody, which can result in a structural height of more than 1 m above the battery area 106b. As already mentioned, the rays of the radiation geometry 100′ are then essentially parallel to the irradiation direction 100s. As the gaps 106s1 and 106s2 also run essentially parallel to the irradiation direction 100s, the X-rays can pass the gaps 106s1 and 106s2 without traversing the battery cells 106b1, 106b2 and 106b3. This allows a sharp imaging of the gaps 106s1 and 106s2 to distinguish them from the battery cells 106b1, 106b2 and 106b3. This allows fast inspection of the inner structure of the battery module 106b incorporated in the vehicle 106 by means of X-radiation. Damages of the battery, such as short-circuit between battery cells, would show by a reduced gap width. In that way, a damage can be determined easily and efficiently. Due to the fact that mainly possible gaps are examined, according to embodiments, the energy level of the radiation source can be reduced, e.g. to 450 KeV or even 360 KeV. This is no longer sufficient for irradiating the battery cell itself, but for irradiating the gap.

Thus, embodiments of the present invention provide an X-ray arrangement or X-ray system including at least the radiation source 112, as well as an X-ray detector 104, that are arranged to each other such that an image of the characteristic cell shape 106b1, 106b2, 106b3 is realized that is as distortion-free as possible. According to embodiments, by continuously moving the scanning unit (102+104) or the object 106+106b along the radiation axis 100s defined by the radiation source 102 and the detector 104, scanning the object 106, in particular 106b, in longitudinal direction can take place. According to an embodiment, the X-ray energy is only selected to the extent that it is possible to get through the metal sheet structure of the vehicle chassis 106, but not necessarily through the components of the battery cells 106b1, 106b2 and 106b3. Detecting is focused on finding the gaps 106s1, 106s2 between the individual battery cells 106b1, 106b2 and 106b3, which can be easily found from a bird's eye view, which usually do not comprise any increased absorption (such that the X-rays of the radiation source 102 can be detected accordingly by the detector 104).

Compared to conventional X-ray systems, such as the X-ray irradiation of large-volume objects such as containers, here, the radiation shape 100s is specifically adapted to the object 106 or 106b to be irradiated. The geometry, in particular the distance 100d′ considering the opening angle 100a′, is selected in dependence on the object to be inspected, or the geometry to be inspected inside the battery cells 106b1, 106b2 and 106b3 integrated in battery modules. General rules for this are, according to embodiments: determining the X-ray source-object distance 100d′ greater than two times, three times, or five times the scanning width or object width 106b. If only part of the object 106b is to be scanned in width direction, the scanning width can also be smaller than the object width in order to image a section. This results in a shorter distance 106b′, but with the same minimum ratio.

Limiting the opening angle of the radiation geometry to 10°, or for example 8°, or 5°. This has the purpose to ensure respective parallelism of the rays in the optical path. According to embodiments, for optimum imaging of the inner structures 106b1, 106b2, 106b3, 106s1, 106s2, an opening angle 100d′ of the ray beam emitted by the X-ray source 102, that is as small as possible, can be selected when, at the same time, a radiation field (see first general point) is as large as possible. This enables circumventing the so-called parallax in the image. In contrast to point-to-point detection by means of a needle-shaped ray, this process is sufficiently more time-efficient and is therefore suitable for fast (serial) inspections. According to embodiments, the limitation can take place by collimating or a collimator (not illustrated) that is coupled to the X-ray source 102.

Aligning the irradiation direction 100s to the gaps 106s1 and 106s2, or generally to the areas to be irradiated with the lowest absorption length or absorption coefficients.

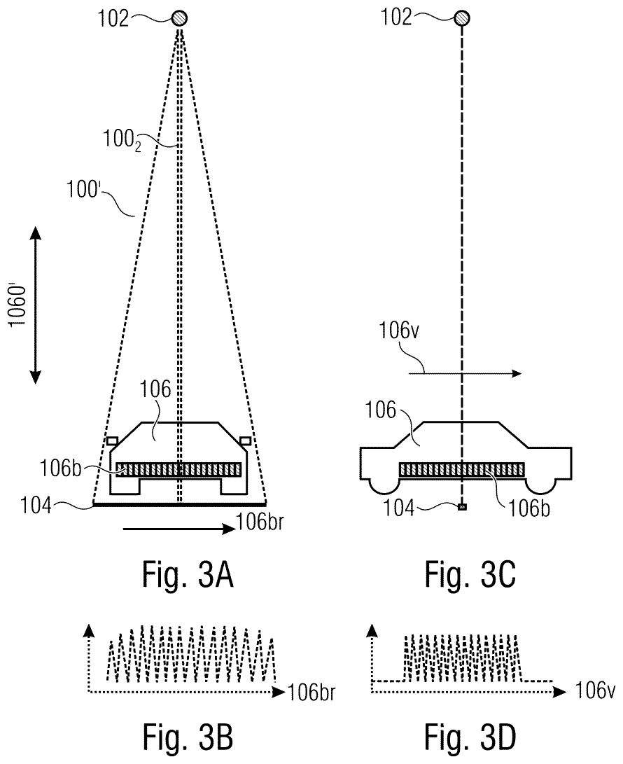

The combination of one or several of these configuration maxima allows a planar radiation geometry, which results, due to a very large distance between source 102 and detector 104, in an almost parallel image of the inner battery cell structure 106b transverse to the vehicle 106, while the longitudinal axis of the vehicle 106, according to further embodiments, can be scanned layer-by-layer in a distortion-free manner, as illustrated based on FIG. 3.

In image 3a1, FIG. 3 shows scanning in transverse direction and in image 3b1 scanning in longitudinal direction.

Basic inspection systems for analyzing battery modules are defined by a particularly large distance between source and detector in order to keep the opening angle as small as possible. As shown in the absorption profile, the gaps can be illustrated across the entire vehicle cross-section.

Radiation source, radiation detector, radiation geometry, object to be irradiated are again indicated by reference numbers 102, 104, 106, 106b, 100′. As can be seen, the distance 100d′ is selected to be very large compared to the object width 106br. As shown in FIG. 3b1, the detector 104 is a line detector arranged in width direction 106br. In order to enable scanning in longitudinal direction of the vehicle 106, or the battery module 106b, the vehicle 106 is moved in advance direction 106v relative to the X-ray system including at least the elements 102 and 104. It should be noted that, according to embodiments, the battery module comprises a plurality of battery cells that are arranged planar (across the vehicle), e.g. in longitudinal and transverse direction (perpendicular to the irradiation direction). For example, the battery cells are arranged in parallel to the irradiation direction, essentially in parallel to the irradiation direction (−5° to +5° or −2° to +2)°. For this, the radiation source 102 is oriented according to embodiments. Thereby, in the longitudinal direction, good scanning of the gaps (cf. minima and maxima in FIG. 3b2) can be determined. The same applies to scanning in width direction as shown by the diagram in FIG. 3a2. Here, sufficiently good scanning results also at the edges of the geometry 100′, without any decrease of the radiation energy by absorption for the gap.

FIGS. 3a2 and 3b2 each plot the irradiation intensity against the scanning direction (width direction 106br in FIG. 3a2 and longitudinal direction or advance direction 106v in FIG. 3b2). When comparing the diagram of FIG. 3a2 with the diagram 1a2, it becomes clear that good scanning can take place also in width direction 106br. The background for this is that sufficient parallelism of the rays of the radiation source 102 is ensured transversely to the vehicle 106 so that there will occur no overlapping of the adjacent battery cells in the production image and hence masking of the gap between the cells. Thus, these areas of the ray cone can all be used for evaluation.

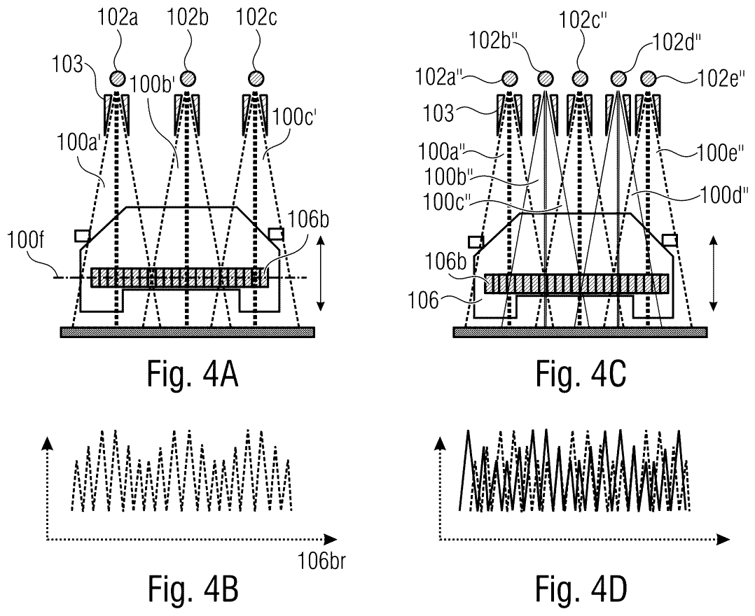

When a large object, such as a vehicle, is scanned in practice, a large X-ray hall is used in order to allow for the large dimensions, in particular the large distance 106d′ between source 102 and object 106b or 102 and 104. Further, a powerful X-ray source 102 with a sufficient power can be or is used. In order to enable a more compact structure according to further embodiments, several X-ray tubes can be used along the vehicle transverse axis 106br. In this case, the radiation source 102 includes several individual radiation sources. In other words, the X-ray system can include several X-ray sources 102a-102c. The X-ray sources 102a to 102c are arranged transversely to the width direction 106br. The same scan an angular area of approximately 10° of the vehicle 106 portion-by-portion, as will be discussed in the context of FIGS. 4a1 and 4b1.

According to an embodiment, the radiation fields 100a′, 100b′, and 100c′ can extend in the depth plane (focal plane) of the battery module 106b. The focal plane is indicated by reference number 100f. As can be seen, minimum overlapping of cones 100a′, 100b′, and 100c′ or a direct abutment of cones 100a′, 100b′, and 100c′ in the focal plane 100f is provided. This enables continuous detection of the battery module 106b.

Arranging several X-ray sources 102a, 102b, and 102c along the vehicle transverse axis 100b′ for segment-by-segment detection of the modules with respective sufficiently small opening angle. Connecting the individual image fields to a continuous overall image takes place via exact localization of the installation height of the battery module within the vehicle. As can be seen in the absorption profile, each source-detector pair only uses the central area of the radiation cone. The projecting areas of the ray cone are collimated so that as little overlap of the adjacent image areas as possible is obtained. In order to optimize the effect for different installation heights of the battery module, the detection system can be varied in its height position. Thus, a simple change between a sedan and a SUV is possible.

The resulting X-ray signal is illustrated in the diagram of FIG. 4a2, again plotted against the width direction 106br.

According to a further embodiment, the radiation fields 100a″ to 100e″ overlap in a large area. For this, the radiation sources 102a″ to 106e″ are arranged closely adjacent to each other along the width direction 106br.

Arrangement of several X-ray sources 102a″, 102b″, 102c″, 102d″, and 102e″ along the vehicle transverse axis for segment-by-segment detection of the modules, wherein the X-ray sources 102a″, 102b″, 102c″, 102d″, and 102e″ each comprise overlapping viewing areas and are connected sequentially to obtain an image having two angular settings in one scan. The switch-on sequence is so short compared to the scan advance that the image area remains approximately constant and a structure is detected from two viewing angles. This imaging mode allows masking of overlapping structures along the irradiation path, such as steering column, seat linkage, or center console. Here, the focal plane is also adapted to the vehicle type.

Here, according to embodiments, the X-ray tubes 102a″ to 102e″ can be operated alternately, which allows imaging of the same structure from different angular ranges. By this approach, spurious influences by overlapping structures, such as the seat linkage or the steering column of the vehicle 106, are minimized.

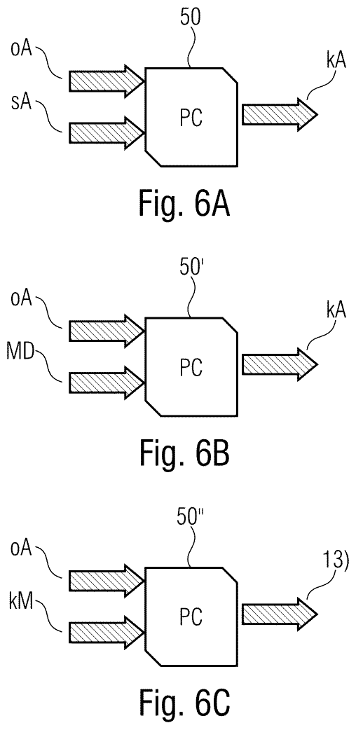

According to embodiments, in the embodiment of FIG. 4a1, a distance reduced approximately by the factor 3 results between the plane where the X-ray sources 102a, 102b, and 102c are arranged and the object 106. In that way, five-fold imaging can be reduced to two-fold imaging. A further reduction is basically possible with several tubes, such as FIG. 4b1, wherein here, for example, the distance is reduced further and the density of the X-ray tubes 102a″ to 102e″ is increased in order to use the above-stated effects of minimizing spurious influences by overlapping structures. The resulting signal of the overlap is illustrated in FIG. 4b2, wherein processing will be explained in the context of FIG. 6.

Here, it should be noted that, according to embodiments, the radiation width of the geometry 100, 100a′, 100b′, 100c′, 100a″ to 100e″ is limited by one collimator 103 per X-ray source 102a to 102c and 102a″ to 102e″, respectively.

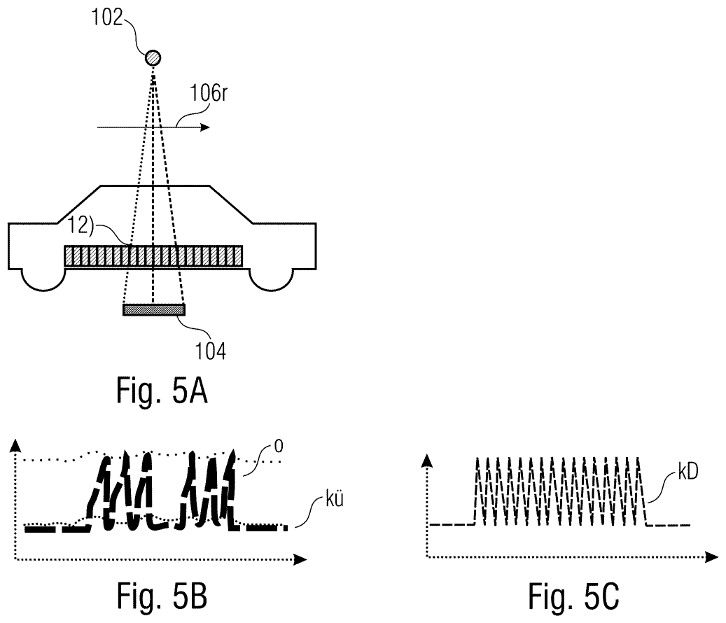

In the embodiments of FIGS. 4a1 and 4b1, it should be noted that the focus is on the image of the object 106 or 106b in transverse direction, i.e., along the width 106br. By the overlap, the plant distance can be designed to be more compact, and, on the other hand, the amount of data can be increased in order to use the additional data for compensation. With reference to FIG. 5a-c, an approach will be discussed how the information content can also be increased in longitudinal direction or advance direction 106v. By using several successively arranged detectors/line detectors or using a planar detector 104′ (cf. FIG. 5a), the cone-shaped ray of the radiation source 102 can be captured at several positions simultaneously along the advance direction 106 in order to acquire additional information which allows, among others, digital laminography, e.g., for evaluating depth information. The information generated by laminography can be used to optimize the pictures as generated, for example, by means of the X-ray system of FIG. 2, 3, or 4. Here, laminography generates a reference of the overlapping structure sA, which can be subtracted from the actually desired, but artifactual dataset kÜ (cf. diagram of FIG. 5b). Thereby, a compensated absorption course with reduced overlaps can be calculated. The same is indicated by reference number kD in FIG. 5c.

This allows, for example, the usage of several line detectors or area detectors along the vehicle longitudinal axis for acquiring data for compensating overlapping structures or for depth-resolved illustration.

In the following, possible processing will be discussed with reference to FIG. 6.

FIG. 6a shows a calculator 50, FIG. 6b a calculator 50′, and FIG. 6c a calculator 50″. The calculators 50, 50′, and 50″ are all configured to determine a compensated absorption course with reduced overlaps, each having a different calculation method. In the following, three different calculating methods are discussed, wherein, according to further embodiments, a combination of two or more calculation methods would be possible.

FIG. 6a shows the calculator 50 configured to determine, based on an orthogonal absorption course oA, the compensated absorption course kA by considering a skewed absorption course sA, skewed with respect to the gaps of the battery cell, detected by another detector area along the vehicle longitudinal axis. This means, according to embodiments, further picture(s) will be taken during skewed irradiation of the object, based on which the picture(s) in orthogonal irradiation are compensated.

The calculator 50′ (FIG. 6b) also calculates the compensated absorption course with reduced overlaps KA, but based on the orthogonal absorption course OA as well as model data MD generated from reference scans of comparable vehicles.

The calculator 50″ (FIG. 6c) calculates the compensated absorption course KA based on the orthogonal absorption course OA as well as Al models KM. The Al models KM are models and networks generated by machine learning, deep learning, etc., based on large samples of connotated data.

The embodiments of FIGS. 6a, 6b, and 6c have shown that in addition to image acquisition which is performed via advancing the vehicle across the detection unit or advancing a detection unit (source and detector) along the vehicle layer-by-layer, image evaluation plays an important part.

The resulting X-ray absorption data are processed in a computing unit and evaluated in an automated manner. Here, the overlaps resulting from peripheral structures are subtracted from the images by image processing operators in order to allow homogenous imaging of the cell structures (KA). Here, in the case of application c), the overlapping image areas are combined such that the area shaded the least by foreign structures is added to the image.

According to embodiments, the calculator is adapted to the well-known structures of the battery modules. By applying methods of machine learning as well as classical image processing methods, the morphological features of the structures to be inspected are defined and evaluated in an automated manner. For prismatic cells, in particular, a deviation from the rectangular cell shape will be detected in that the longitudinal gap within the cell is measured. For cylindrical cells, the roundness of each cell and its distance to the adjacent cells is determined, which allows an indication of a deformation of the module. With sufficiently high irradiation energy, the degree of filling of the electrolyte liquid within the cells can be determined. In the case of leakage, a significant decrease of the absorption within the respective cell can be expected.

According to embodiments, by means of the method, deviations in the overall form of the module can be determined. For example, the battery frame can be inspected for form deviations in order to be able to judge the influence of a damage caused by an accident. Also, detecting foreign particles within the cells and modules is possible.

Thus, the evaluation method can be generalized as follows:
determining, e.g., by means of the X-ray apparatus from FIG. 2, FIG. 3a1, FIG. 3b1, or FIG. 4a1 and FIG. 4b1, or possibly performing the aspect of FIG. 5a-c of an orthogonal scan;
compensating overlaps based on the data of the obtained scan by considering reference data, data determined based on artificial intelligence or on pictures taken based on skewed irradiation (skewed relative to the object width or skewed relative to the object length).

According to embodiments, for example, based on the orthogonal irradiation picture and the skewed irradiation picture, an overlapping object can be detected and the overlapping object can be removed from the orthogonal picture.

With reference to FIG. 7, overlapping objects will be illustrated.

FIG. 7a shows an irradiation picture where overlapping objects are indicated by reference numbers 70a, 70b, 70c, 70d, and 70e, which overlap the plurality of circular battery cells 72. Examples for the overlapping objects are, for example, the back seat 70d, the center console 70a, the seat linkage 70b, or also the B-pillar 70c. The measurement illustrated in FIG. 7a also serves as comparative measurement from a skewed irradiation and can be considered in the actual picture of the axis position of FIG. 7b, which illustrates the battery cells 72 with good resolution.

FIG. 7c shows in reference numbers 74a, 74b, and 74c three potentially detectable errors. The error 74a shows a form-deviating result of an expansion of a cell. The error 74b illustrates a density variation due to electrolyte leakage. The error 74c illustrates a contacting error/connection break.

FIG. 7d shows further errors 74d, 74e, and 74f. Error 74d is the detection of cell compressions/displacements. Error 74e on the other hand is caused by a density variation due to electrolyte leakage. Error 74f is a contacting error/connection break.

Here, it should be noted that, according to the embodiments, an irradiation of a battery module takes place. The battery module typically comprises cells. According to the embodiments, these cells are arranged along the width direction and/or along the advance direction. Thereby, it is obtained that irradiation of the cells takes place such that the gaps between the cells are longitudinally irradiated, i.e., are arranged essentially along the direction of the X-radiation or the radiation direction. According to embodiments, the object to be irradiated is arranged such that boundaries between cells of the object to be irradiated run along the irradiation direction.

Applications of the above-discussed concepts are the analysis of batteries/high-voltage batteries of electric vehicles or hybrid vehicles, e.g., after occurrence of an accident, when selling the vehicle, or for clarifying the vehicle history or for vehicle assessments. These applications are particularly interesting for second-hand car market. However, inspection can also take place prior to shipment from the manufacturer at the factory (digital vehicle file for comparison during the lifecycle) prior to vehicle transport on cargo ships, (e.g., in the port). Advantages are the fast inspection method with a detection period of approximately 5 minutes. The method can be used for all common battery module designs, e.g., prismatic or cyclical designs. As explained above, by respective algorithms or Al, analysis automation for supporting the inspector can take place.

According to embodiments, the object to be irradiated can be arranged in a container or fire-retardant container. Here, it would also be possible that the memory module or also the entire vehicle is arranged in a fire-retardant container. These fire-retardant containers can, for example, be part of the irradiation apparatus. Alternatively, it would also be possible that the fire-retardant container forms the object to be irradiated while an object to be inspected is arranged within the same.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. X-ray system for non-destructive material inspection of a battery module of a vehicle to be irradiated or a battery module incorporated in a vehicle, comprising:
at least one radiation source;
at least one radiation detector;
wherein the object to be irradiated can be arranged between the at least one radiation source and the at least one radiation detector, wherein the at least one radiation source is arranged spaced apart from the object to be irradiated with at least five times the width of the scanning area, such that a fan-shaped radiation geometry is formed at least in transverse direction, wherein the scanning area of the width of the object, wherein the scanning area corresponds to the width of the object in transverse direction, or wherein the scanning area corresponds to a part of the width of the object in transverse direction;
wherein the opening angle of the radiation geometry is less than 5° in transverse direction and wherein the opening angle of the radiation geometry is less than 10° in advance direction.

2. X-ray system according to claim 1, wherein the distance between the at least one radiation source to the object to be irradiated is at least 3 m, or at least 5 m, or at least 10 m, or at least 11 m; and/or
wherein the object to be irradiated comprises a plurality of battery modules arranged along the transverse direction.

3. X-ray system according to claim 1, wherein the object can be moved in advance direction and/or can be moved continuously in advance direction perpendicular to the transverse direction for scanning; and/or
wherein the object to be irradiated comprises a plurality of cells that are arranged along the advance direction.

4. X-ray system according to claim 1, wherein the at least one radiation source is formed by several individual radiation sources, or wherein the at least one radiation source is formed by several individual radiation sources arranged transverse to the object.

5. X-ray system according to claim 4, wherein the radiation geometries of the individual radiation sources comprise overlapping radiation fields and/or radiation fields overlapping in the focal plane; or
wherein the radiation geometries of the individual radiation sources comprise overlapping radiation geometries; or
wherein the radiation geometries of the individual radiation sources comprise overlapping radiation geometries and wherein the individual radiation sources are configured to be operated alternately.

6. X-ray detector according to claim 1, wherein the X-ray detector extends across the entire width of the object; and/or
wherein the X-ray detector is formed by a line detector or area detector, which extends across the entire width of the object.

7. X-ray system according to claim 1, wherein the X-ray system comprises several radiation detectors or radiation sources arranged along an advance direction.

8. X-ray system according to claim 1, wherein the radiation source or the individual radiation sources are collimated, or each comprise a collimator that defines the radiation geometry with <10°.

9. X-ray system according to claim 1, wherein the distance between the at least one X-ray source and the object to be irradiated and/or the at least one radiation detector can be adjusted.

10. X-ray system according to claim 1, wherein the at least one X-ray source provides an energy of a maximum of 450 KeV or of a maximum of 360 KeV; and/or wherein the energy is selected to be so low that no irradiation of an intact object or an intact battery cell takes place.

11. X-ray system according to claim 1, further comprising an evaluation apparatus configured to evaluate several pictures across several positions and/or several pictures across several radiator/detector combinations; or
further comprising an evaluation apparatus configured to evaluate several pictures across several positions and/or several pictures across several radiator/detector combinations and wherein the evaluation apparatus is configured to detect overlapping objects in the individual pictures based on the several pictures and/or to compensate the image of the overlapping object in the individual pictures.

12. X-ray system according to claim 1, wherein the X-ray system comprises an evaluation apparatus configured to detect an overlapping object based on a reference picture of the object to be irradiated and/or to compensate the image of the overlapping object in individual pictures.

13. X-ray system according to claim 12, wherein only the evaluation apparatus is configured to select the picture with little or no overlap.

14. X-ray system according to claim 1, wherein the X-ray system further comprises an evaluation apparatus that is based on an Al algorithm and/or is configured to detect morphological features; or
wherein the X-ray system further comprises an evaluation apparatus that is based on an Al algorithm and/or is configured to detect morphological features, wherein the evaluation apparatus is configured to detect deviations of the object or parts of the object from a normal form.

15. X-ray system according to claim 14, wherein the evaluation apparatus is configured to determine a distance between two parts of the object, in particular between two battery cells.

16. X-ray system according to claim 1, wherein the object is a battery module that comprises several battery cells arranged in parallel, in particular cylindrical battery cells or prismatic battery cells, wherein the irradiation direction of the radiation source is oriented in parallel or essentially in parallel to the battery cells; and/or
wherein the object is a battery module comprising a plurality of battery cells that are arranged in a planar distributed manner.

17. X-ray system according to claim 1, wherein the X-ray system comprises a container or fire-retardant container in which the object to be irradiated is arranged; and/or
the object to be irradiated comprises a container or fire-retardant container in which an object to be inspected, in particular a vehicle or a battery module of a vehicle, is arranged.

18. Method for determining an X-ray picture by using an X-ray system according to claim 1, comprising:
irradiating an object to be irradiated at a distance of the radiation source from the object to be irradiated of at least two times, at least three times, or at least five times the width of the scanning area to acquire a first picture, such that a fan-shaped radiation geometry is formed, at least in transverse direction;
wherein the scanning area corresponds to the width of the object in transverse direction, or wherein the scanning area corresponds to part of the width of the object in transverse direction.

19. Method according to claim 18, wherein the method comprises repeating irradiating for a further picture, or wherein the method comprises repeating the irradiation for a further picture as well as compensating an overlapping object based on detecting the overlapping object in the picture with the help of the further picture; or
wherein the further picture is taken with skewed irradiation of the object skewed to the width and the picture is taken with orthogonal irradiation in relation to the width; or
wherein the method comprises arranging the radiation object such that cells of the object to be irradiated are arranged along a transverse direction and/or along an advance direction.

20. A non-transitory digital storage medium having a computer program stored thereon to perform the method for determining an X-ray picture by using an X-ray system, the method comprising:
irradiating an object to be irradiated at a distance of the radiation source from the object to be irradiated of at least two times, at least three times, or at least five times the width of the scanning area to acquire a first picture, such that a fan-shaped radiation geometry is formed, at least in transverse direction;
wherein the scanning area corresponds to the width of the object in transverse direction, or wherein the scanning area corresponds to part of the width of the object in transverse direction,
when said computer program is run by a computer.
